(19) United States
(12) Patent Application Publication
(10) Pub. No.: US 2020/0227986 A1
(43) Pub. Date: Jul. 16, 2020

(54) WINDING MACHINE

(71) Applicant: SMZ WICKEL- UND MONTAGETECHNIK AG, Wurenlos (CH)

(72) Inventors: Mario STRAUB, Zürich (CH); René SCHNEEBELI, Zürich (CH)

(73) Assignee: SMZ WICKEL- UND MONTAGETECHNIK AG, Wurenlos (CH)

(21) Appl. No.: 16/638,942

(22) PCT Filed: Jul. 12, 2018
(86) PCT No.: PCT/EP2018/068954

§ 371 Date: Feb. 13, 2020

(30) Foreign Application Priority Data
Aug. 16, 2017 (EP) 17186429.1

(51) Int. Cl. H02K 15/095; B65H 57/06

(52) U.S. Cl. CPC H02K 15/095; B65H 57/06

(57) ABSTRACT

The invention relates to a winding module (2) for a winding device for automatically winding coils for an electric machine, comprising a module structure (20), a needle carriage (24) having a needle (25), wherein the needle carriage (24) is mounted in the module structure (20) such that it can move along a first direction (R). The winding module (2) has a winding material clamping device (240) for clamping the winding material (8), which is designed to secure the winding material (8) against rotation and against shifting along the needle axis (250), wherein the winding material clamping device (240) is arranged in or on the needle carriage (24). The invention also relates to a module frame and a winding device having a module (2) of this type.

### TECHNICAL FIELD

The present invention relates to a winding module and a module frame and a winding device having at least one winding module for winding coils for electrical machines.

### PRIOR ART

Winding modules and winding machines are known. Thus, for example, it is known that a winding device which has a plurality of winding stations is used and that winding members are simultaneously wound with the needle winding technique.

### SUMMARY OF THE INVENTION

An object of the present invention is to provide a winding module which allows an improved winding method.

This object is achieved by the winding module according to claim 1. Accordingly, a winding module for a winding device for automatically winding winding material is proposed. The winding material is in particular wire, for example, copper wire, of typical diameters, but particularly also diameters of 1 mm and more. The winding material is wound in this instance on a winding member, in particular in grooves of the winding member, in order to produce a coil for an electrical machine.

The winding module comprises a module stand. The module stand forms the frame of the winding module, in which the components of the winding module are received.

The winding module further comprises a needle carriage with a winding needle. The needle carriage is the carrier which carries the needle, wherein the needle is preferably releasably fastened in a fixed manner on or in the needle carriage. The releasability allows simple exchange of the needle. The needle is also referred to as a winding nozzle. The winding material is discharged in the direction of the winding member from the mouth opening thereof. The needle carriage is supported in the module stand in a displaceable manner in a first direction (Z stroke direction). The first direction is preferably the vertical direction during the correct winding use of the winding module, and therefore extends in the direction of gravitational force. However, it is also possible for the first direction to be located differently in space.

The above-mentioned object is now achieved in that the winding module further has a winding material clamping device for clamping the winding material which is configured in order to secure the winding material to prevent torsion about and to prevent displacement along the needle axis (or a longitudinal extent of the winding material) and this winding material clamping device is arranged in or on the needle carriage.

The winding material clamping device can be activated selectively so that it forms a rotation prevention member which prevents the winding material from rotating about its own axis with the rotation prevention member activated. The winding material clamping device further acts at the same time as a slip prevention member which prevents the winding material from moving in an undesirable manner in the longitudinal direction thereof in the winding material channel if the winding material clamping device is activated. Consequently, optimum control of the winding material during the winding process is provided. Typically, the winding material clamping device is activated at times between the winding phases in which the winding material is discharged out of the needle. During the winding phases, it is typically deactivated in order not to disrupt the running of the winding material.

The present invention is based on the recognition that the winding material clamping device can be integrated directly into the needle carriage, and therefore also moves during the winding with the needle carrier. This allows a particularly lightweight construction type, whereby a rapid winding runner can be produced. In particular, this clamping device no longer has to be fitted on an additional external axle, whereby weight and costs are saved.

The present invention particularly also allows a large number of rotors and/or stators to be wound at the same time with a plurality of teeth, wherein each tooth is preferably wound in sequence. The present invention is also advantageous if it is desirable to wind wire diameters of more than 1 mm.

In a preferred embodiment, the winding material clamping device has a clamping lever which is supported on or in the needle carriage. The clamping lever is movable between a clamping position and a release position. Preferably, the lever is fixed to a lever bearing and is pivotable. In the clamping position, that is to say, with the winding material clamping device activated, the clamping lever is pivoted in such a manner that it engages with the winding material which is located in the winding material channel and securely clamps it correctly. In the release position, the clamping lever is pivoted in such a manner that it releases the winding material during correct use so that it can be discharged by the needle to the winding member.

In a preferred development, the clamping lever is constructed as a two-armed lever. Preferably, the two lever arms are located in a manner inclined or angled relative to each other and particularly form an L-shaped lever. The L-shaped lever allows a compact construction with relatively long lever arms, which is optimum for the force redirection. Other lever shapes, such as, for example, a linear two-armed lever or a one-armed lever are also conceivable. Even a plurality of clamping levers can be provided.

In a development, the clamping lever is movable via a lever actuator.

The L-shaped clamping lever is particularly preferable wherein the lever actuator is surrounded at two sides by the L-shaped lever. In other words: preferably, the lever actuator is arranged between the two lever arms. This allows a particularly compact construction type.

In a preferred embodiment, the lever actuator has a movably supported eccentric element. Preferably, the eccentric element is supported in or on the needle carriage by means of an axle rotatably about the axle. The eccentrically projecting portion can then act on a lever arm of the lever in accordance with the rotary position. If the lever arm is itself supported on an axle, the lever arm can thus be pivoted by the eccentric element.

The return movement relative to this clamping lever movement which is caused by the eccentric element can, for example, be brought about by a resilient element, against which the eccentric element preferably acts indirectly via the lever. The clamping lever and/or the eccentric element can therefore be pretensioned, in particular in the clamping position, by means of a tensioning device. The tensioning device may have a resilient element, in particular a pressure spring and/or tension spring element, preferably a helical spring.

Preferably, this resilient element is adjustable. For example, there may be provided an adjustment screw in order to adjust the tension of the spring. As a result of the adjustability, it is possible for the winding material clamping device to be adjusted in a suitable manner with respect to the winding material, for example, the winding material diameter and/or the tension on the winding material. This is particularly the case when the pretensioned position is the clamping position and the actuation of the lever actuator brings about the movement into the release position. Other adjustment mechanisms can naturally also be used.

The lever actuator may preferably be actuatable via a hydraulic device, preferably a pneumatic cylinder, for moving the clamping lever. Other actuators, such as servo motors or magnetic actuators, can also be used in order to bring about the movement of the lever between the clamping position and the release position.

Alternatively, the winding material clamping device may also carry out the clamping engagement when the winding material clamping device is activated with a cylinder or a set of pincers or other means or clamping elements. The clamping elements are preferably pretensioned with respect to a movement direction so that only the other movement direction has to be actively brought about.

In a development, the needle carriage has a winding material channel which is preferably closed in a radially circumferential manner in order to guide the winding material through the needle carriage to the needle. Preferably, this winding channel extends centrally through the needle carriage. The term “centrally” is intended to be understood in this instance to mean that the winding material channel extends symmetrically with respect to a guided width, that is to say, for example, substantially centrally between any guide rails for the needle carriage and/or substantially centrally with respect to a guided height of the needle carriage in the direction of the guide rails (Z direction).

The guided height/width is intended to be understood to mean the distance between the outer support locations of the carriage with the guide; any overhang (that is to say, what extends behind the guide) is disregarded. If the carriage is a plate, therefore, which is guided along the thickness, a construction on the plate which projects freely and which does not have any direct contact with the guide does not count toward the guided height.

As a result of this central arrangement, that is to say, the central arrangement with respect to the guided width and/or height, the forces which are applied by the winding material during the winding to the needle carriage and consequently to the winding module can be optimally taken up. These forces act symmetrically with respect to the displaceable needle carriage. As a result, only minimal torques act on the needle carriage. The tendency to tip is minimized, which allows a particularly advantageous travel movement.

In a preferred embodiment of the winding module, the module stand has a guide device, wherein the needle carriage is guided on the guide device in the first direction. The guide device can preferably have at least one, preferably two or more, guide rail(s) which is/are opposite with respect to the needle carriage transversely to the first direction and which preferably extend(s) in the first direction. The needle carriage can be displaceably supported on these guide rails. Preferably, the needle carriage has for each guide rail a through-recess, through which the guide rail extends. As a result, a circumferentially closed enclosure of the guide rail is provided by the needle carriage, which allows a particularly precise and robust guiding. Preferably, the needle carriage engages on the guide rail via sliding, rolling or other suitable bearings and is thus displaceable in a low-friction manner.

In order to activate the winding material clamping device, the winding module further has a torque shaft in a preferred embodiment. A rotary movement from the outer side can be introduced into the winding module via this torque shaft and leads to the activation of the lever actuator, therefore in preferred embodiments to the rotation of the eccentric element.

The torque shaft preferably extends parallel with the at least one guide rail. The torque shaft itself can also provide a guiding action for the travel movement of the needle carriage. Preferably, the torque shaft is guided through the needle carriage. Preferably, the torque shaft extends substantially over the length of the at least one guide rail. As a result, the lever actuator which is displaceable in the needle carriage over the length of the guide rail(s) can be activated over substantially the entire travel path.

The present invention further relates to a module frame in which a plurality of the winding modules according to the invention can be inserted. To this end, the module frame has a large number of receiving members, preferably 2, 3, 4, 5, 6, 7, 8 or more receiving members for winding modules, wherein preferably at least one winding module is inserted in the module frame. Preferably, an even number of receiving members is provided. The receiving members are configured to releasably fix the plurality of winding modules. For each winding application, the suitable number of modules can readily be inserted. This modularity allows a particularly versatile use of the module frame or module or the winding device as a whole.

The module frame is a fixed frame for mounting a plurality of winding modules for the simultaneous winding of a plurality of coils. As a result of the fixed spatial connection of the inserted winding modules, the module frame can then be moved as a whole in order to bring about an additional stroke movement, the Y stroke, in addition to the needle carriage movement (Z stroke). Preferably, the Z direction and the Y direction are substantially perpendicular to each other. In particular, the Z direction can extend in the vertical direction (for example, in the direction of gravitational force) and the Y direction can extend in the horizontal direction (as, for example, along the winding table).

For the purposes of the present description, therefore, the movement of the needle carriage in the module frame is referred to as the Z stroke movement, and the movement of the module frame is referred to as the Y stroke movement. The third spatial direction movement (X stroke movement) can then be carried out, for example, by a switching unit which can bring about a rotational movement about the Z axis. The Y and Z stroke directions and preferably also the X stroke direction are preferably substantially perpendicular to each other, respectively.

The present invention is particularly suitable for a needle winding technique. However, other techniques can also be used.

In a development, the module frame comprises a single rotation element or at least a pair comprising a first and a second rotation element. The rotation element can be coupled to any winding module so that a rotational movement of the at least one rotation element can be converted into the travel movement of any carriage (Z stroke) which is located in the module frame. Therefore, the rotational movement of the single rotation element or at least one pair comprising a first and a second rotation element can be introduced into the winding module via the coupling.

Preferably, in the development of the module frame with a pair comprising rotation elements, the first and second rotation elements of the pair are supported in a rotatable manner on or in the module frame with spacing from each other in the first direction, preferably substantially over a height of the winding module. Thus, for example, the rotational movement can be introduced from the module frame from below and from above into the winding module.

In a development, the module frame further has a coupling device which converts the rotational movement of the single rotation element or the pair of rotation elements into the travel movement of the at least one needle carriage which is located in the module frame. Accordingly, the coupling device is coupled in terms of movement to the single rotation element or coupled in terms of movement to at least one rotation element of the at least one pair comprising a first and second rotation element, wherein the coupling device is further connected in terms of movement to the needle carriage so that the needle carriage can be moved in the first direction via the rotational movement of the single rotation element or the at least one rotation element of the at least one pair comprising a first and second rotation element. In this case, the coupling of the needle carriage and the connection device is preferably readily releasable in order to assemble the winding module rapidly in the frame and disassemble it again.

It is particularly preferable in the embodiments with a pair of rotation elements for the rotational movement of the first and second rotation element of the pair to be coupled, for example, by a synchronization drive, such as a thread or a belt drive. A synchronous and cleanly guided movement is thereby possible, which helps to achieve a particularly high winding speed.

In a development of the module frame, the first rotation element is a first shaft or a first disk which is supported on a first shaft, in particular a toothed disk, and the second rotation element is a second shaft or a second disk which is supported on a second shaft, in particular a toothed disk. The coupling device can then be configured as a belt drive and may further have a carriage belt for forming a belt drive with the first and second rotation element.

The carriage belt is preferably configured as a toothed belt and the first and second rotation elements of the pair are preferably configured as toothed disks; together, they form a toothed belt drive.

It is particularly preferable for the module frame to have one or two shaft(s), wherein on each shaft one disk per winding module receiving member is provided. Via this disk, the rotational movement of the single rotation element or the pair of rotation elements can then be coupled from the frame into the module, which leads to the linear Z movement of the needle carriage.

A configuration with two shafts and accordingly one disk per shaft for each winding module or each receiving member is particularly preferable, wherein the carriage belt forms a belt drive with these two belts. In this case, first and second belt ends can preferably be fixed via clamping plates to the first or second rotation element (therefore, to the shaft or the disks which are fitted to the shaft in a rotationally secure manner).

The carriage belt preferably extends in the first direction. As a result, a particularly simple conversion of the rotational movement of the at least one rotation element into the linear movement of the needle carriage is possible.

The open belt allows simple coupling of the needle carriage to the belt drive. In particular, the belt has to be guided only once by or on the carriage. In particular, the winding material has to be guided only once by the belt with an open belt. For the purpose of simple disassembly of the module from the module frame, the belt can be releasably fixed directly to the needle carriage. The open belt can in particular be releasably fixed to the needle carriage via a clamping plate integrated in the needle carriage so that the belt can be disconnected simply by releasing the clamping plate from the needle carriage.

In a development, therefore, the carriage belt is releasably fixed to the needle carriage, preferably via a clamping plate which is fitted to the needle carriage. Other possible fixing means are also conceivable.

In order to obtain a movement of the needle carriages which is as synchronous as possible, it is preferable for all the single rotation elements and/or the first and second rotation elements to be driven, preferably via at least a first servo motor or via precisely one single first servo motor. The movement can further be made uniform by the provision of synchronization drives. Thus, for example, in modules with two shafts the two shafts can be coupled via a synchronization drive, for example, at least one additional belt drive. These synchronization drives can preferably be provided at the end of the shafts on the module frame.

Therefore, a module frame is preferable wherein the first and second shafts are connected in a rotationally secure manner via at least one additional synchronization device, preferably in such a manner that the shafts rotate in the same direction; and wherein the synchronization device preferably has a synchronization belt which is preferably configured as a toothed belt.

In a preferred embodiment, therefore, the Z stroke of all the winding modules inserted can be brought about via a single first servo motor.

The single first servo motor is preferably coupled via a first belt drive to the/the first rotation element(s) and preferably via a second belt drive to the/the second rotation element(s), if present.

The belt drives which are mentioned herein preferably have a tension disk, via which the tension of the belt can be adjusted.

In principle, the belt drives mentioned herein can also be replaced by toothed wheel gear mechanisms, push rods or other movement transmission elements.

An object of the present invention is to provide a winding device which allows an improved winding of coils, preferably using the needle winding technique.

This object is achieved by the features of claim 13. Accordingly, there is proposed a winding device for automatically winding, preferably using the needle winding technique, winding material, in particular wire in grooves of a winding member, in order to produce a coil for an electrical machine, in particular an armature or externally grooved stator. The winding device comprises a machine frame, a table plate having at least one switching unit for receiving and switching (X stroke) the winding member, and a module frame according to the invention (for the synchronous Y stroke, see below), as described herein, wherein the at least one winding module according to the invention (which allows the Z stroke), as described herein, is preferably fixed in the module frame in such a manner that the first direction (Z) is perpendicular to the second direction (Y). Since the switching unit preferably causes a rotational movement of the winding member perpendicularly to the table plate, that is to say, in the Z direction, the X stroke is then substantially perpendicular to the Y stroke and Z stroke.

In a development of the winding device, the module frame is movable relative to the table plate in a second direction and thus all the winding modules which are fixed in the module frame are movable in the second direction (Y stroke).

Preferably, the winding device has at least one, preferably precisely one single, second servo motor for moving the module frame in the second direction.

According to a particularly preferred embodiment, therefore, a single first servo motor for bringing about the Z stroke (of each winding module) and a single second servo motor for bringing about the Y stroke (entire module frame) are provided. This allows an easy, cost-effective and reliable construction of the winding device. The X stroke can then be brought about via one or more third servo motors. Therefore, one or more third servo motors can be provided, wherein, in the case of a plurality of third servo motors with each third servo motor at least one, preferably precisely two or more, switching unit(s) can be switched at the same time (for example, via a coupling by means of a belt drive).

According to a development of the winding device, there are provided 2, 3, 4, 5, 6, 7, 8 or more preferably individually removable winding modules in the same module frame, wherein preferably an even number of 2, 4, 6, 8 or more winding modules are or can be fixed in the module frame.

In a preferred development of the winding device, a plurality or all of the winding material clamping devices which are received in the respective needle carriages of the winding modules are coupled to each other, preferably coupled in terms of movement via a push rod. It is particularly preferable for a plurality or all of the winding material clamping devices to be actuatable via one, preferably the same, hydraulic device, preferably a hydraulic, in particular pneumatic, cylinder. However, other actuation devices are also conceivable in this instance, for example, a Bowden cable or electric motors. According to the present invention, the winding module according to the invention, the module frame according to the invention and the winding device according to the invention can be used to wind coils, in particular armatures or externally grooved stators, for an electrical machine. In this case, there is preferably used as the winding material wire, in particular wire having a diameter of from 0.5 mm to 2 mm, preferably of more than 1 mm, preferably from 1 mm to 1.5 mm.

### BRIEF DESCRIPTION OF THE DRAWINGS

Preferred embodiments of the invention are described below with reference to the drawings, which are merely explanatory and which are not intended to be interpreted in a limiting manner. In the drawings:

FIG. 1 shows an embodiment of a winding device according to the invention having a module frame and winding modules inserted;

FIG. 2 is a first detailed cross-section of the winding device according to FIG. 1;

FIG. 3 is a perspective front view of an embodiment of the module frame according to the invention according to FIG. 1 with 6 winding modules each having a displaceable needle carriage;

FIG. 4 is a perspective rear view of the module frame according to FIG. 3;

FIG. 5 is a second detailed cross-section of the winding device according to FIG. 1;

FIG. 6 is a perspective front view from above of a detail of the winding module with the needle carriage according to FIG. 1;

FIG. 7 is a side view of the winding module according to FIG. 6;

FIG. 8 is a cross-section through the needle carriage according to FIG. 6;

FIG. 9 shows an embodiment of a winding material clamping device which is arranged in the needle carriage according to FIG. 8;

FIG. 10 shows an embodiment of a hydraulic device which is fitted in the module frame for actuating the winding material clamping device of the winding modules; and

FIG. 11 shows an embodiment of a switching device having two switching units which are connected via a belt drive to a servo motor.

### DESCRIPTION OF PREFERRED EMBODIMENTS

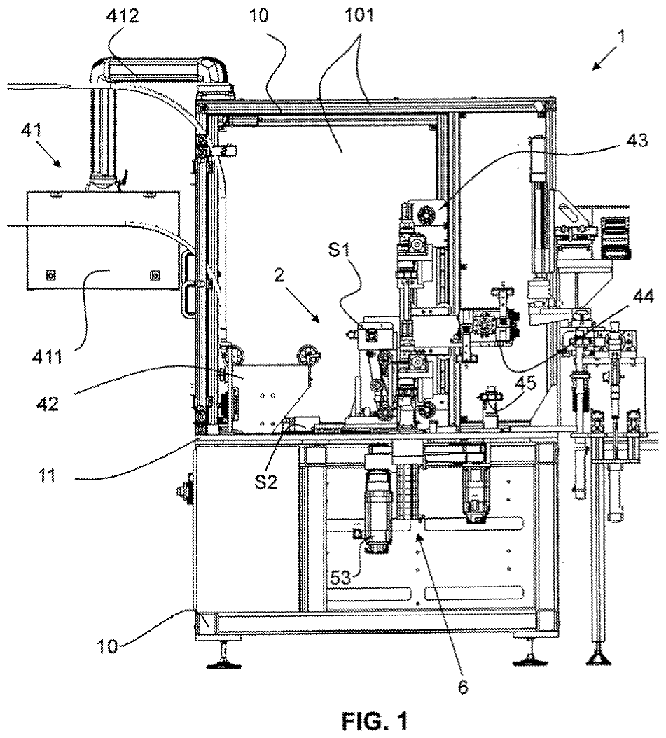

With reference to FIGS. 1 to 11, preferred embodiments of the present invention will now be described. In this instance, metal wire 8 is used as the winding material.

FIG. 1 shows a winding device 1 having a machine frame 10. The winding device 1 further has a control cabinet 41, a wire supply 42, a wire clamping and cutting unit 43 for suspending the wire in commutators 7, a loading handling unit 44 and a switching unit 6. Furthermore, the winding device 1 has a module frame 12 having a large number of winding modules 2.

The machine frame 10 is welded and assembled from square steel pipes. A table plate 11 which acts as a base for additional functional groups is fitted in the machine frame 10. The machine frame 10 is partially provided with a safety sheeting 101. The safety sheeting 101 may comprise grooved profiles of aluminum. Doors are secured with door protection retention members. Other constructions are possible.

The control cabinet 41 has an operating panel for operating the winding device 1. The control cabinet 41 is integrated at the rear side in the machine frame 10. The operating panel 411 is rotatably suspended on a boom 412 in front of the winding device 101.

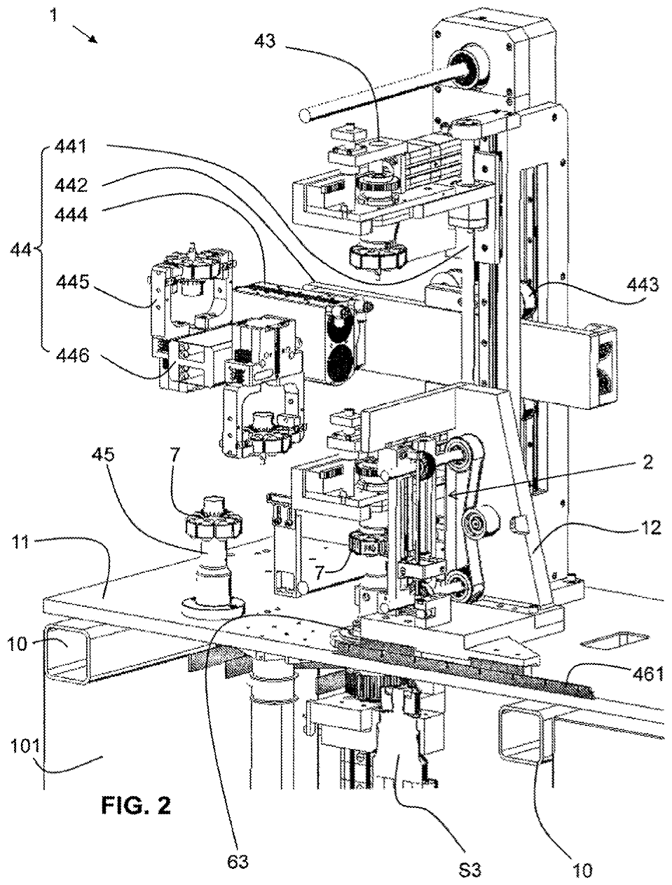

FIG. 2 is a cross-section through the winding device 1 according to FIG. 1. In the foreground (bottom right), one of the winding modules 2 can be seen and is fitted in the module frame 12. The module frame 12 is itself supported on the table 11 in the machine frame 10. The module frame 12 is arranged in a linearly displaceable manner on a guide device 46 (Y stroke). A first guide rail 461 of the guide device 46 can be seen in FIG. 2, which rail 461 extends in the Y direction.

The loading handling unit 44 is shown above the module frame 12. The loading handling unit 44 has two laterally arranged supports 441 on which there is provided a runner 441 which extends transversely relative to the support 441. The loading handling unit 44 has two supports 441 which are arranged laterally in the winding device 1 on the table 11 and which each have an extension arm 442. The extension arms 442 are arranged parallel with each other and are freely movable via two servo motors in two axes. The synchronization of the two extension arms 442 is carried out via a drive rod in the drive axle of the motors. The movement of the extension arms 442 is brought about via a circumferential toothed belt 443 in a crosswise arrangement. This drive concept is also referred to as “T-bot”. A pneumatic rotary unit 444 is flange-mounted on the extension arm 442 at both sides. The receiving bar 445, which is rotatably supported by means of the rotary units 444 for the product grippers 446, is located between these rotary units 444. Two grippers 446 are always arranged opposite each other per winding module 2. This double gripper system allows loading and unloading in a state released from the winding process. The sequence is as follows: after a product 7 is completely wound with the coil 5, one gripper 446 approaches, a tension unit is released, the handling unit 44 travels away upward, rotates through 180° and inserts the unwound product 7 with the other gripper 446 in the tension unit. This is carried out simultaneously for all the winding modules 2. After the handling unit 44 has moved away, the winding process can be started. At the same time, the unloading of the wound stators onto a support 45 (waiting position) or a material carrier is now carried out.

FIG. 2 further shows a portion of the wire clamping and cutting unit 43 for suspending the wire 8 on commutators. The unit 43 is arranged above the winding module 2. The unit 43 contains two main functions, that is to say (i) a clamping sleeve presses the start wire 8 via a vertical, pneumatic drive into a groove base of the first hook on the commutator so that the first windings can be wound; and (ii) via a horizontal, pneumatic drive, a blade receiving sleeve is moved in rotation via a toothed rack. Via a cutting edge of the outer sleeve, the wire 8 is separated and bent around the hook by the blade member. The wire end is thereby prevented from touching the wire 8 in the adjacent hook.

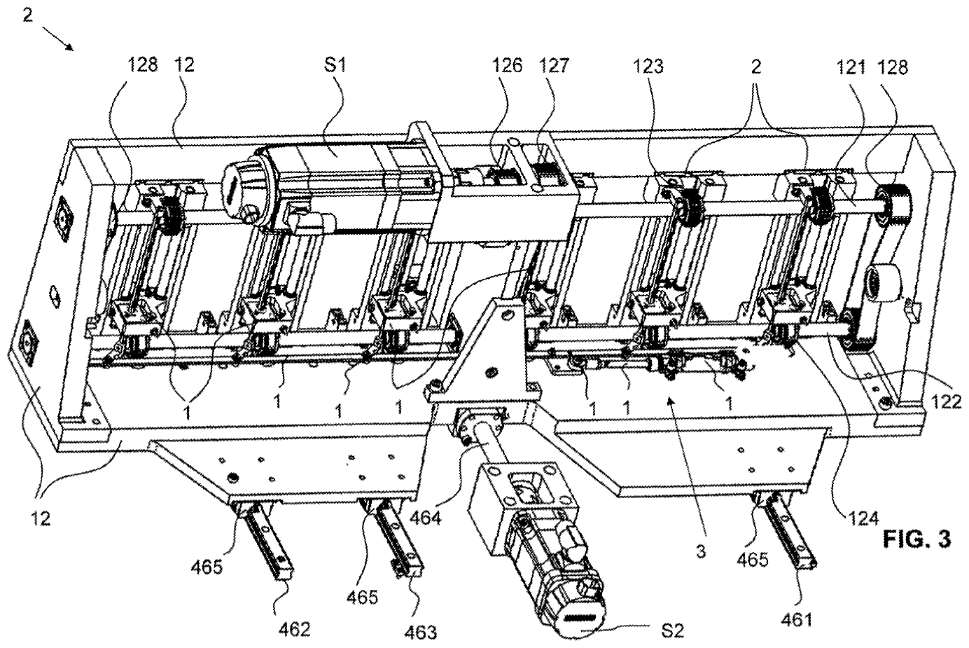

FIG. 3 shows the module frame 12 in a front view. The module frame 12 has two trapezoidal side walls which are connected to each other via a base plate and a strut which is arranged opposite and parallel with respect to the base plate. A first shaft 121 extends in the upper region between the side walls over the entire length of the module frame 12. A second shaft 122 which also extends over the entire length of the module frame 12 is arranged with spacing from the first shaft 121 in the Z direction. The first shaft and second shaft 121, 122 are connected to each other in a rotationally secure manner laterally via a synchronization drive 128. To this end, disks which are arranged in a rotationally secure manner are fitted to each shaft 121, 122 at the end in each case. Toothed disks of the synchronization drive 128 which are spaced apart from each other in the Z direction are now coupled in terms of movement via a closed toothed belt. A tension disk which ensures the correct tension of the belt of the belt drive 128 is provided centrally between the toothed disks which are connected via the belt drive.

Six equidistantly distributed winding modules 2 are arranged over the length of the frame 12. The first shaft 121 and the second shaft 122 each have for each winding module 2 a first toothed disk 123 and second toothed disk 124 which are fitted in a rotationally secure manner on the shaft 121, 122, respectively. Therefore, there are provided on the first and second shafts 121, 122 six first toothed disks 123 and six second toothed disks 124. In embodiments having more or fewer receiving members for winding modules 2, naturally a corresponding number of first and second toothed disks 123, 124 can be provided. The receiving members on the module frame are therefore distinguished by the toothed disks and corresponding fixing means for fixing the respective module stand 20.

Via a first servo motor 51, which engages on the first shaft 121 via a first belt drive 126 and on the second shaft 122 via a second belt drive 127, both shafts 121, 122 are driven by motor and coupled in terms of movement via the synchronization drives 128.

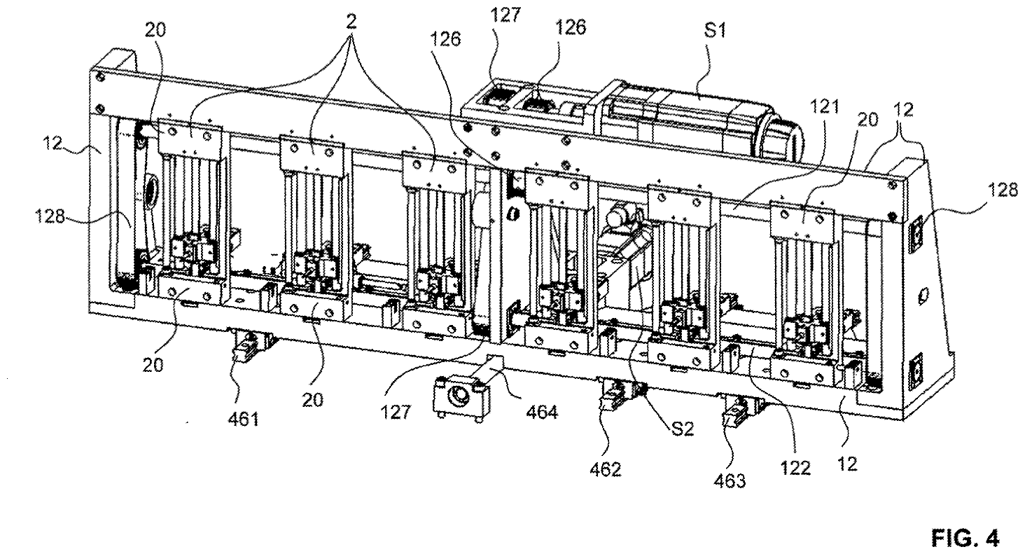

FIG. 4 shows the module frame 12 in a rear view. It can be seen that module stands 20 of the winding modules 2 are each screwed to the base plate and to the upper strut of the frame 12 in the receiving members.

FIGS. 3 and 4 further show that the module frame 12 is supported on the guide device 46, which has the first guide rail 461 and the two additional rails 462, 463. The module frame 12 has travel units 465 which are associated with the guide rails 461 to 463 and on which the module frame 12 can then be moved on the rails 461 to 463. In principle, fewer rails would naturally also be sufficient, in particular the two outer rails 461, 462 provide a stable guide and the third guide rail 463 reduces the play further.

The module frame 12 is now moved in the Y direction via a second servo motor S2 which engages on the module frame 12 via a rod 464 which extends in the Y direction and which makes it movable in the Y direction (Y stroke).

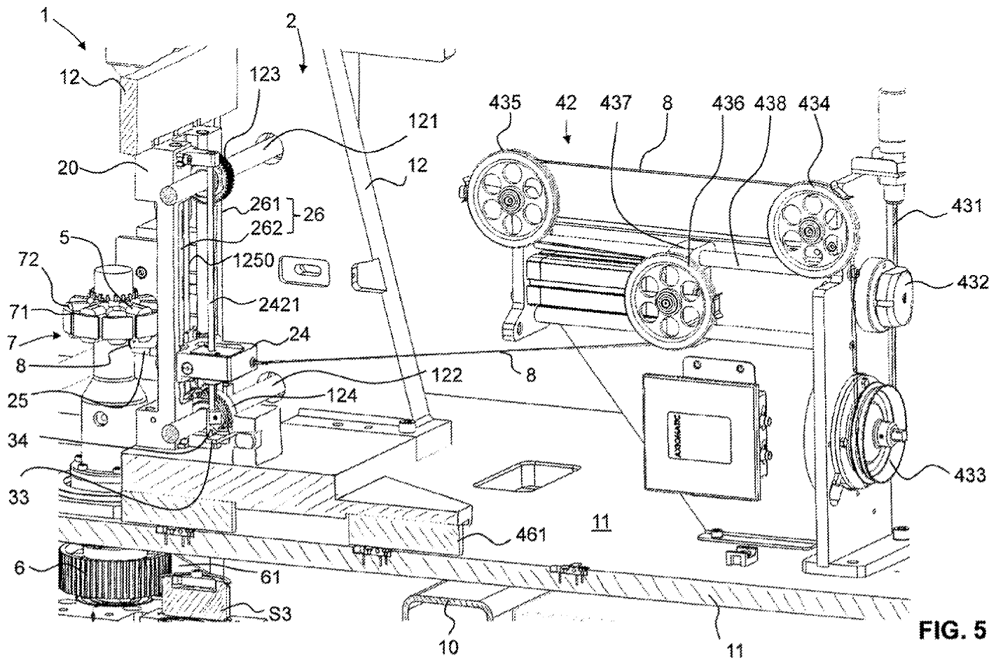

FIG. 5 is a cross-section through the winding device 1. The wire supply 42, which is arranged on the table 11 of the machine frame 10, can be seen. The wire supply 42 is provided with wire brakes and a wire compensation mechanism. The wire supply 42 supplies the wire via a guide hose. After a preliminary brake 432, the wire 8 is wound around a Vulkollan-coated braking roller 433 of the magnetic powder brake (540°) and guided in a vertical direction around a first redirection roller 434 after a 90° redirection around a second redirection roller 435 and, from there, back to the compensation roller 436. The compensation roller 436 is pressed against the winding module 2 on a guide carriage 437 in a horizontal direction by a pneumatic cylinder 438 with free-running properties. This compensation pressure is adjusted via a proportional valve via a control unit. Thus, it is ensured that during the winding process loose wire 8 is never produced and the wire drawing remains constant. The individual wire unrollers (not shown) are screwed behind the winding module 2 on the table plate 11 of the winding device 1 and are thus accessible for changing the wires in an optimum manner.

Furthermore, on the left-hand side, FIG. 5 shows the module frame 12 and a winding module 2 with a module stand 20, the first shaft 121 having the first toothed disk 123 is again arranged in the upper region of the winding module 2 and the second shaft 122 having the second toothed disk 124 is arranged in the lower region. The two toothed disks 123, 124 are coupled in terms of movement via an open toothed belt 1250 of a connection device 125, which belt extends in the Z direction. The toothed belt 1250 is fixed on the needle carriage 24. The needle carriage 24 is further arranged between two guide rails 261, 262 which are provided in the winding module 2 and are thus displaceable via movement of the shafts 121, 122 along the guide rails 261, 262 in the Z direction. The guide rails 261, 262 are guided through the recesses 246 (through-openings) through the needle carriage 24. The needle carriage 24 is provided in the region of the recesses 246 with bearings 2460 so that it is possible for the needle carriage 24 to slide along the guide 26 with as little friction as possible.

The winding member 7, which is tensioned on the switching unit 6, is located in front of the module 2. The winding member 7 has a large number of teeth 72 which are separated via grooves 72. The winding module 2 has a needle carriage 24 which is displaceable in the Z direction and which has a needle 25, from which the wire 8 is inserted in the grooves 71 for winding round the teeth 72, whereby the coil 5 is formed.

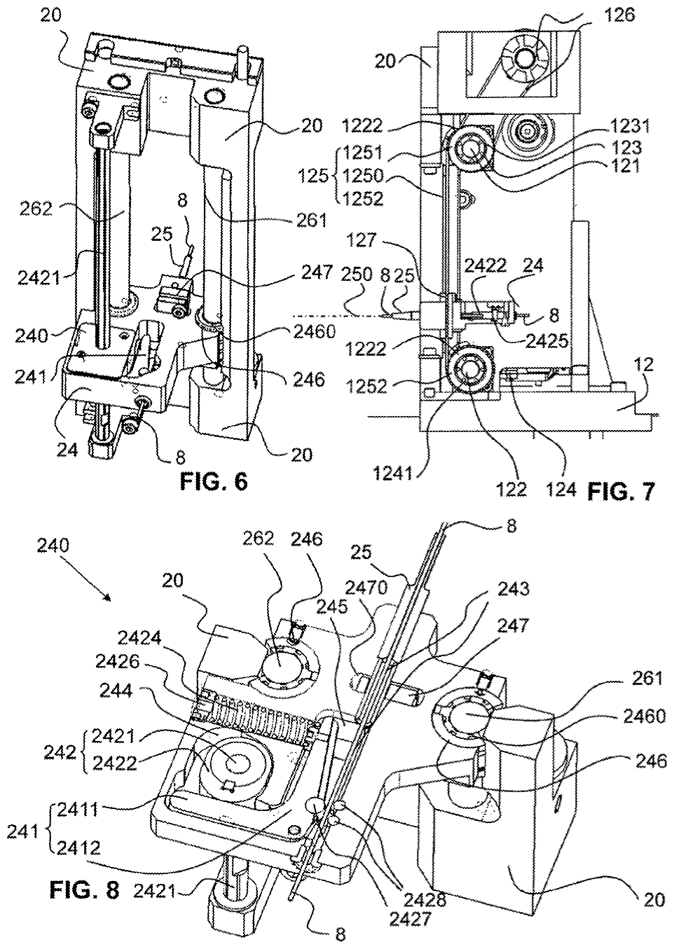

FIG. 6 shows the winding module 2 in a perspective view from above. FIG. 7 shows the winding module 2 in the frame 12 in a side view.

The substantially parallelepipedal module stand 20 having the central through-opening can be seen. The two guide rails 261 and 262 are laterally fitted. The needle carriage 24 is arranged so as to be displaceable in the Z direction between these rails 261, 262.

The needle carriage 24 has an additional through-opening for the introduction of a torque shaft 2421. The torque shaft 2421 engages on a winding material clamping device 240 which is arranged in the needle carriage 24. FIG. 6 shows how the wire 8 is guided through an opening into the interior of the needle carriage and is discharged again at the opposite end by the needle 25 along the needle axis 250 (see FIG. 7).

FIG. 7 further shows the first belt drive 126, via which the first servo motor S1 engages on the first shaft 121. The tension disk of the first belt drive 126 can also be seen.

The details of the connection device 125 can further be seen in FIG. 7. The first belt disk 123 having a tooth arrangement 1231 is connected to an upper portion 1251 of the toothed belt 1250 of the belt drive 125 via a clamping plate 1222. The belt 125 is guided through the opening 2470 (see FIG. 8) through the needle carriage 24 and securely clamped with the clamping plate 247 (see also FIGS. 6 and 8). In the lower region 1252, the belt 1250 is connected to the lower second toothed disk 124 with a tooth arrangement 1241 via an additional clamping plate 1222. In the situation according to FIG. 7, it can be seen that the belt 1250 is then already largely wound around the toothed disk 124 and engages with the tooth arrangement 1253 in the tooth arrangement 1241 of the disk 124, and the needle carriage 24 is therefore located in a lower position.

FIGS. 6 and 7 also show the clamping lever 241 of the winding material clamping device 240.

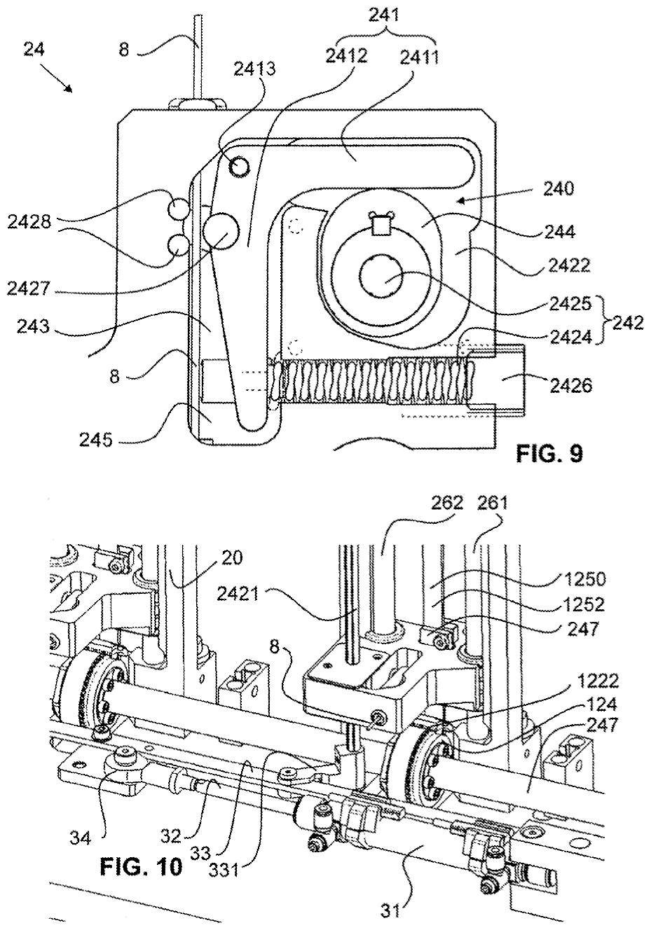

FIGS. 8 and 9 show a cross-section through the needle carriage 24, whereby the winding material clamping device 240 can be seen. The winding material clamping device 240 has the clamping lever 241, which can be pivoted as required via a lever actuator 242. The winding material clamping device 42 further has an eccentric element 242. The clamping lever 241 is a two-armed clamping lever having a first arm portion 2411 and a second arm portion 2412. The lever 241 is constructed in an L-shaped manner and is arranged in a substantially L-shaped recess 245 in the needle carriage 24 centrally with respect to the Z direction. The lever 241 is pivotably supported on the lever bearing 2413 in the needle carriage 24.

The clamping lever 241 interacts with the eccentric element 242 via the first arm portion 2411. The eccentric element 242 is arranged in a rotationally secure manner on the torque shaft 2421, which forms the axis of the eccentric element 242. If the torque shaft 2421 is now rotated, the eccentric element 242 also rotates accordingly. FIGS. 8 and 9 show that the eccentric element 242 is an eccentric disk which can press on the first lever portion 2411 depending on the rotation position with a thickened portion and can thus press the clamping lever 241 which is pretensioned in the clamping position into the release position.

Via the second arm portion 2412, which extends substantially parallel with the winding material channel 243, the clamping lever 241 can engage in the clamping position with any wire 8 which is introduced in the winding material channel 243 and can securely clamp it at that location so that it does not twist about its own axis or slip in the longitudinal direction thereof. To this end, the lever arm 2412 is provided with a clamping element 2427 which makes direct contact with the wire 8. The abutments 2428 are provided opposite the clamping element 2427 so that an optimum clamping location in the needle carriage 24 can be provided. The second lever portion 2412 tapers toward the free end thereof. Furthermore, the engagement location of a resilient element 2424 is located at the free end of the lever arm 2412 for pretensioning the lever 241 in the clamping position. The resilient element 2424 is constructed as a pressure spring which can be adjusted in terms of the tension thereof via the adjustment screw 2426.

FIG. 9 also shows an inlet opening into and an outlet opening out of the needle carriage 24, which openings are provided for the introduction of the wire 8. The inlet opening and the outlet opening are connected by the winding material channel 243. The winding material channel 243 extends substantially centrally between the two guide rails 261, 262 and substantially centrally with respect to the Z extent of the needle carriage 24. Torques on the needle carriage 24 are thereby minimized.

FIG. 10 shows a hydraulic device 3 for moving the respective torque shafts 2421. The torque shafts 2421 are connected at the lower end via L-shaped pieces 331 to a push rod 33 which extends parallel with the table 11. This push rod 33 is connected via an articulation 34 to an actuation piston rod 32 which is supported in a pneumatic actuation cylinder 31 of the hydraulic device 3. Therefore, with the actuation of the actuation cylinder 31 the push rod 33 is moved forward or backward with respect to the cylinder 31 so that the L-shaped connection pieces 331 and therefore the torque shaft 4421 are rotated. Accordingly, therefore, the eccentric elements 2422 of the mounted winding modules 2 can be rotated by the actuation of the hydraulic device 3.

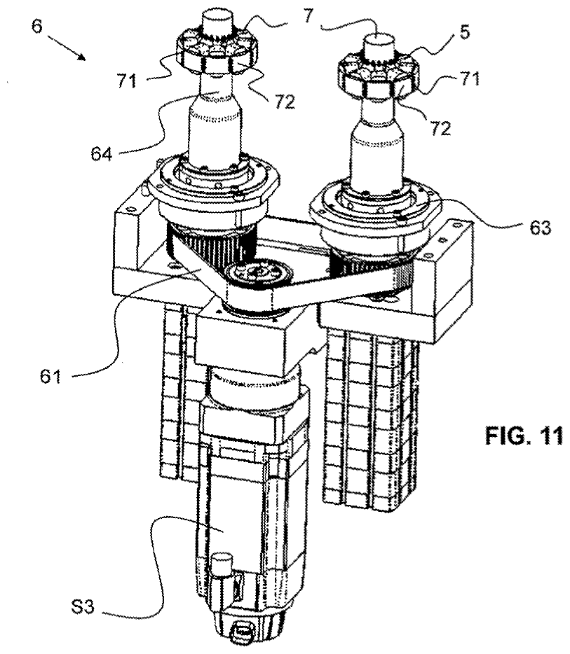

FIG. 11 shows the switching unit 6 has a switching axle 62 and is supported by a double-row of ball bearings 63 in a receiving housing which is inserted in the table plate 11. The drive is produced via a toothed belt drive 61. A tension unit comprising a set of tensioning pincers is inserted in the receiving mandrel 64. This set of tensioning pincers is configured for the shaft diameter of the winding member 7 and is tensioned via a disk spring assembly. In order to release this tension, pressure can be applied from below with a mandrel against the disk spring assembly. The set of tensioning pincers thereby opens because it is lifted off a cone. The switching axles 62 are driven in pairs via a toothed belt drive 61. A third servo motor S3 is fitted so as to be offset laterally centrally relative to the axles 62. This switching unit 6 can now be fitted several times and allows machine variants with 4, 6 or 8 winding spindles. In place of tensioning units with sets of tensioning pincers (tensioning of shafts), receiving members for stators can also be provided with tensioning mandrels (tensioning in holes).

LIST OF REFERENCE NUMERALS

| | |
|---|---|
| 1 | Winding device |
| 10 | Machine frame |
| 101 | Safety sheeting |
| 11 | Table plate |
| 12 | Module frame |
| 120 | Receiving member |
| 121 | First shaft |
| 1211 | Tooth arrangement of 123 |
| 1212 | Clamping plate |
| 122 | Second shaft |
| 1222 | Clamping plate |
| 123 | First rotation element, disk |
| 1231 | Tooth arrangement of 123 |
| 124 | Second rotation element, disk |
| 1241 | Tooth arrangement of 124 |
| 125 | Coupling device |
| 1250 | Carriage belt |
| 1251 | First end of 1250 |
| 1252 | Second end of 1250 |
| 1253 | Tooth arrangement of 1250 |
| 126 | First belt drive |
| 127 | Second belt drive |
| 128 | Synchronization belt drive |
| 2 | Winding module |
| 20 | Module stand |
| 24 | Needle carriage |
| 240 | Winding material clamping |
| | device |
| 241 | Clamping lever |
| 2411 | First lever arm |
| 2412 | Second lever arm |
| 2413 | Lever bearing |
| 242 | Lever actuator |
| 2421 | Torque shaft |
| 2422 | Eccentric element/disk |
| 2423 | Tensioning device |
| 2424 | Resilient element |
| 2425 | Axle |
| 2426 | Adjustment screw |
| 2427 | Clamping element |
| 2428 | Abutment |
| 243 | Winding material channel |
| 244 | Recess for 242 |
| 245 | Recess for 241 |
| 246 | Recess for 261 or 262 |
| 2460 | Bearing |
| 247 | Clamping plate |
| 2470 | Recess in 24 for 247 |
| 25 | Needle |
| 250 | Needle axis |
| 26 | Guide device for 24 |
| 261 | First guide rail of 26 |
| 262 | Second guide rail of 26 |
| 3 | Hydraulic device, pneumatic |
| | cylinder |
| 31 | Actuation cylinder |
| 32 | Actuation piston rod |
| 33 | Push rod |
| 331 | Connection of 2421 and 33 |
| 34 | Articulation |
| 41 | Control cabinet |
| 441 | Operating panel |
| 442 | Boom |
| 42 | Wire supply with wire brakes |
| | and wire compensation |
| | mechanism |
| 43 | Wire clamping and cutting |
| | unit for suspending the wire |
| | in commutators |
| 431 | Guide hose |
| 432 | Preliminary brake |
| 433 | Braking roller |
| 434 | First redirection roller |
| 435 | Second redirection roller |
| 436 | Compensation roller |
| 437 | Guide carriage for 436 |
| 438 | Pneumatic cylinder |
| 44 | Loading handling unit |
| 441 | Support |
| 442 | Extension arm |
| 443 | Toothed belt in crosswise |
| | arrangement |
| 444 | Pneumatic rotary unit |
| 445 | Receiving bar |
| 446 | Product gripper |
| 45 | Waiting position |
| 46 | Guide device for 2 |
| 461 | First guide rail of 46 |
| 462 | Second guide rail of 46 |
| 463 | Third guide rail of 46 |
| 464 | Rod |
| 465 | Travel unit |
| 5 | Coil |
| 6 | Switching unit |
| 61 | Belt drive |
| 62 | Switching axle |
| 63 | Ball bearing |
| 64 | Receiving mandrel |
| 7 | Winding member |
| 71 | Grooves |
| 72 | Winding tooth |
| S1 | First servo motor |
| S2 | Second servo motor |
| S3 | Third servo motor |

1. A winding module for a winding device for automatically winding winding material, in order to produce a coil for an electrical machine, wherein the winding module comprises:
a module stand;
a needle carriage with a needle, wherein the needle carriage is supported in the module stand in a displaceable manner in a first direction,
wherein the winding module further has a winding material clamping device for clamping the winding material; wherein the winding material clamping device is configured in order to secure the winding material to prevent torsion about and to prevent displacement along the needle axis; and wherein the winding material clamping device is arranged in or on the needle carriage.

2. The winding module as claimed in claim 1,
wherein the winding material clamping device has a clamping lever which is supported on or in the needle carriage and which is movable between:
a clamping position, in which the winding material clamped by the clamping lever during correct use of the winding module;
a release position, in which the clamping lever releases the winding material during correct use of the winding module for movement relative to the needle.

3. The winding module as claimed in claim 2,
wherein the clamping lever is movable via a lever actuator, and
wherein the lever actuator has a movably supported eccentric element.

4. The winding module as claimed in claim 1,
wherein the needle carriage has a winding material channel in order to guide the winding material through the needle carriage to the needle.

5. The winding module as claimed in claim 1,
wherein the module stand has a guide device, and
wherein the needle carriage is guided on the guide device in the first direction.

6. The winding module as claimed in claim 3 which further has a torque shaft in order to rotate the eccentric element.

7. A module frame for a plurality of winding modules as claimed in claim 1, comprising at least one winding module, wherein the module frame has a plurality of receiving members to releasably fix the plurality of winding modules.

8. The module frame as claimed in claim 7, further comprising a single rotation element or at least a pair comprising a first and a second rotation element,
wherein the first and second rotation elements of the pair are supported in a rotatable manner on or in the module frame with spacing from each other in the first direction,
wherein the module frame further comprises a coupling device;
wherein the coupling device is connected in terms of movement to the single rotation element or connected in terms of movement to at least one rotation element of the at least one pair comprising a first and second rotation element; and
wherein the coupling device is further connected in terms of movement to the needle carriage;
so that the needle carriage can be moved in the first direction via the rotational movement of the single rotation element or the at least one rotation element of the at least one pair comprising a first and second rotation element.

9. The module frame as claimed in claim 8,
wherein the first rotation element is a first shaft or a first disk which is supported on a first shaft and the second rotation element is a second shaft or a second disk which is supported on a second shaft; and
wherein the connection device has a carriage belt for forming a belt drive with the first and second rotation elements.

10. The module frame as claimed in claim 9, wherein the carriage belt is open.

11. The module frame as claimed in claim 9, wherein the carriage belt is releasably fixed to the needle carriage.

12. The module frame as claimed in claim 8,
wherein at least one of i) all the single rotation elements and ii) the first and second rotation elements are driven.

13. A winding device for automatically winding winding material in order to produce a coil for an electrical machine, wherein the winding device comprises:
a machine frame,
a table plate having at least one switching unit for receiving and switching the winding member, and
a module frame as claimed in claim 8.

14. The winding device as claimed in claim 13, wherein the module frame is movable relative to the table plate in a second direction and thus all the winding modules which are fixed in the module frame are movable in the second direction.

15. The winding device as claimed in claim 13, wherein at least one of
i) there are provided 2, 3, 4, 5, 6, 7, 8 or more removable winding modules in the same module frame; and
ii) one or more third servo motors are provided, wherein with each third servo motor at least one switching unit(s) can be switched.

16. The winding device as claimed in claim 13, wherein a plurality or all of the winding material clamping devices are coupled to each other, and are actuatable via one, hydraulic device.

17. A method of using a winding module, of a module frame as claimed in claim 7 comprising winding coils for an electrical machine.

18. The winding module as claimed in claim 3, wherein at least one of:
i) at least one of the clamping lever and the eccentric element is/are pretensioned, by means of a tensioning device; and
ii) the lever actuator is actuatable via a hydraulic device for moving the clamping lever.

19. The winding module as claimed in claim 5, wherein the guide device has at least one guide rail which is at least one of i) opposite with respect to the needle carriage transversely to the first direction and ii) extends in the first direction.

20. The winding module as claimed in claim 6, wherein the torque shaft at least one of i) extends parallel with the at least one guide rail and ii) extends over the length of the at least one guide rail.

21. The module frame as claimed in claim 10, wherein first and second belt ends are fixed via clamping plates to the first or second rotation element; and
wherein the open carriage belt extends in the first direction.

22. The module frame as claimed in claim 11, wherein the carriage belt is releasably fixed to the needle carriage via a clamping plate which is fitted to the needle carriage.

23. A method of using a winding device as claimed in claim 13, comprising winding coils for an electrical machine.
